(19) United States
(12) Patent Application Publication
(10) Pub. No.: US 2010/0218744 A1
(43) Pub. Date: Sep. 2, 2010

(54) Engine and a selectively movable assembly incorporating the engine and a method for concomitantly increasing both the output torque and the efficiency of an internal combustion engine

(76) Inventor: Bernard Joseph Simon, Troy, MI (US)

Correspondence Address: Bernard Joseph Simon, 3831 Eastbourne, Troy, MI, 48084, US

(21) Appl. No.: 12/380,530

(22) Filed: Feb. 27, 2009

(51) Int. Cl. F02B 75/04

(52) U.S. Cl. 123/48 B

(57) ABSTRACT

A selectively movable assembly 10 having an engine 12 which includes a body portion 26 which includes a plurality of cylinders, such as cylinders 30, 32 and each cylinder includes a pair of selectively movable pistons, such as pistons 40, 42, whose use cause the engine 12 to be highly efficient while concomitantly providing a relative high amount of torque or output power.

### GENERAL BACKGROUND

1. Field of the Invention

The present invention generally relates to an engine and to a selectively movable assembly which incorporates the engine and to a method for concomitantly increasing both the output torque and the efficiency of an internal combustion engine and, more particularly, to a new and novel engine which delivers exceptional torque while having reduced frictional losses with respect to conventional engines, such as internal combination engines.

2. Background of the Invention

An engine is operatively deployed in a selectively movable assembly to provide output power or torque which is used, at least in part, to selectively drive wheel assemblies, effective to allow the selectively movable assembly to be driven or moved. One non-limiting example of such a selectively movable assembly is an automobile and one non-limiting example of such an engine is an internal combustion engine in which a mixture of air and gas is selectively combusted by a plurality of spark plugs, effective to move contained pistons which impart rotational force upon a crankshaft. The subsequent rotation of the crankshaft provides power or torque to wheel assemblies and such power or torque is then used to drive or move the assembly. Such power or torque may also, in part, be used for other operations, such as to operate a winch.

While such internal combustion engines do provide torque and power, they do not operate very efficiently. By way of example and without limitation, the movement of the contained pistons causes frictional losses to occur which undesirably reduces the amount of power or torque which is provided by the engine and which increases the overall fuel consumption of the selectively movable assembly. Engine friction tends to increase at a rate greater than the square of engine operating speed, such that friction losses increase by more than fourfold with a doubling of engine speed. Although strategies such as replacing crank assembly bushings with bearings have been shown to reduce friction, the effect is minimal as friction is inherent in the design of a conventional engine due to the imbalance of the generated forces.

Consider a conventional engine as illustrated in FIG. 3. It contains a piston 1 constrained in a cylinder 2 and connected to rod 4 by pivot-joint 3. The rod 4 is connected to a crankshaft 6 by pivot-joint 5. The inlet valve 7, exhaust valve 8, and spark plug 9 are at the end of the cylinder 2 and housed in a manifold (not shown). Volume 20 is the volume bounded by the piston 1, cylinder 2, inlet valve 7, exhaust valve 8, the head assembly (not shown) which houses the inlet valve 7 and exhaust valve 8, and spark plug 9.

The engine generates power through a four stroke process: Intake, Compressions, Power, and Exhaust. The Intake stroke starts when the piston 1 is at or near its minimum stroke and the volume 20 is minimized (the minimal volume point is often referred to as ‘Top Dead Center’). The inlet valve 7 is opened and fuel and air are allowed to flow into the cylinder 2. The crankshaft 6 rotates and, through connecting rod 4, pulls the piston 1 down and creates a vacuum in the bounded volume 20 which draws the fuel and air in. FIG. 4 shows the system after the crankshaft 6 has rotated 90 degrees and the Intake cycle is about 50% complete.

The Compression stroke starts after the crankshaft 6 has rotated approximately 180 degrees and piston 1 is at or near the bottom of the cylinder 2. The point at which the bounded volume 20 is maximized is often referred to as ‘Bottom Dead Center’. FIG. 5 illustrates the system near the start of the Compression stroke. The inlet valve 7 is closed and the crankshaft 6 continues to rotate and, through connecting rod 5, pushes the piston 1 upward back towards top dead center, compressing the fuel-air mixture enclosed in volume 20. FIG. 6 illustrates the system about half-way into the compression stroke. With both inlet valve 7 and exhaust valve 8 closed, the fuel-air mixture in bounded volume 20 is compressed as the bounding volume decreases in size.

The Power stroke begins after the crankshaft 6 has further rotated approximately 180 degrees and, through connecting rod 5, the piston 1 has been pushed to or near top dead center and the gases are desirably compressed. FIG. 7 shows the system near the start of the Power stroke. Both inlet valve 7 and exhaust valve 8 remain closed during the stroke. The compressed fuel-air mixture in volume 20 is ignited by a spark from the spark plug 9. The ignition causes rapid heat-up of the compressed gases, causing the pressure in the volume 20 to rise rapidly. The pressure in the volume 20 exerts a force on the piston 1, forcing it downward. This force is transmitted through the connecting rod 4 to the crankshaft 6, and useful energy is now generated by the engine.

The Exhaust stroke begins after the crankshaft 6 has further rotated approximately 180 degrees and the piston 1 is at or near bottom dead center. The exhaust valve 8 is opened and the crankshaft 6 pushes the piston 1 back towards top dead center. This action pushes most of the combusted gases out of the bounded volume 20. When the crank has moved the piston 1 to or near top dead center, the exhaust valve 8 is closed and the next Intake stroke begins. FIG. 8 shows the system at the start of the Exhaust stroke after the exhaust valve 8 has opened.

FIG. 9 shows the engine of FIG. 3 during the Power stroke, after the crankshaft 6 has rotated 90 degrees. The arrow 10 shows the direction of travel of the piston, as well as the direction of the force from the pressurized gas in volume 20 on the piston. Arrow 11 shows the direction of the forces generated in the connecting rod 4. Because force 11 in connecting rod 4 is not aligned with vector 10, a reaction force 12 is generated along the walls of cylinder 2. Likewise, the force imparted by the connecting rod 4 on crankshaft 6 must also be balanced, giving rise to reaction force 13. Both force vectors 12 and 13 perform no useful work but instead give rise to friction. The friction generated by these reaction forces can be mitigated if the direction of travel of piston 1 were aligned with the reaction force in rod 4, and if the force imparted by the rod 4 on crankshaft 6 were balanced by another useful force.

There is therefore a need and it is a non-limiting aspect and object of this invention to provide a new and novel engine which has reduced frictional operating losses and increased torque or power production. There is also a need and it is a non-limiting aspect and object of this invention to provide a new and novel methodology for concomitantly increasing both the output torque and the efficiency of an internal combustion engine.

### SUMMARY OF THE INVENTION

It is a first non-limiting object of the present invention to provide an engine which overcomes at least some of the previously delineated drawbacks of previous engines.

It is a second non-limiting object of the present invention to provide a new and novel strategy which overcomes some or all of the drawbacks of prior engine strategies which were and are directed to increasing overall efficiency.

It is a third non-limiting object of the present invention to provide an engine having desirably efficiency and torque output.

It is a fourth non-limiting object of the present invention to provide a methodology for concomitantly increasing overall output torque and efficiency provided by an internal combustion engine.

According to a first non-limiting aspect of the present invention, an engine is provided. Particularly, the engine has a body into which at least one cylinder is formed: a plurality of pistons which are movably disposed within the at least one cylinder; a crankshaft; a plurality of arm assemblies, wherein each of the plurality of arm assemblies connects a unique one of the pistons to the crankshaft; at least one spark plug which is operatively disposed within the at least one cylinder and which is selectively energizable, wherein the selective energization of the at least one spark plug causes each of the plurality of pistons to move in a respectively unique direction within the at least one cylinder and wherein the movement of each of the plurality of pistons causes each of the plurality of arm assemblies to cooperatively rotate the crankshaft, thereby causing the engine to provide rotational energy.

According to a second non-limiting aspect of the present invention, an engine is provided and includes a body into which a cylinder is formed; a first piston which is movably disposed within the cylinder; a second piston which is movably disposed within the cylinder; a crankshaft; a first arm assembly which couples the first piston to the crankshaft; a second arm assembly which couples the second piston to the crankshaft; a spark plug which is operatively disposed within the cylinder, which is positioned between the first and the second pistons while being closer to the first of the pistons and which is selectively energizable, wherein when the spark plug becomes selectively energized the first and the second pistons are made to move away from each other in opposite directions within the cylinder, effective to cause the first and second arm assemblies to cooperatively rotate the crankshaft, thereby providing rotational energy.

According to a third non-limiting aspect of the present invention, a selectively movable assembly is provided and includes an engine having a body into which at least one cylinder is formed: a plurality of pistons which are movably disposed within the at least one cylinder; a crankshaft; a plurality of arm assemblies, wherein each of the plurality of arm assemblies connects a unique one of the pistons to the crankshaft; at least one spark plug which is operatively disposed within the at least one cylinder and which is selectively energizable, wherein the selective energization of the at least one spark plug causes each of the plurality of pistons to move in a respectively unique direction within the at least one cylinder and wherein the movement of each of the plurality of pistons causes each of the plurality of arm assemblies to cooperatively rotate the crankshaft, thereby causing the engine to provide rotational energy.

According to a fourth non-limiting aspect of the present invention, a method for concomitantly increasing the output torque and the efficiency of an internal combustion engine of the type having at least one contained and selectively movably piston is provided. Particularly, the method includes the step of reducing the speed of movement of said piston within the engine.

These and other features, aspects, and advantages of the present invention will become apparent from a reading of the detailed description of the preferred embodiment of the invention, including the subjoined claims, and by reference to the enclosed drawings.

### BRIEF DESCRIPTION OF THE DRAWINGS

FIG. 1 is a block diagram of a selectively movable assembly which is made in accordance with the teachings of the preferred embodiment of the invention.

FIG. 2 is a partial schematic view of an engine which is made in accordance with the teachings of the preferred embodiment of the invention and which is shown in FIG. 1.

FIG. 3 is a partial schematic of a conventional internal combustion engine.

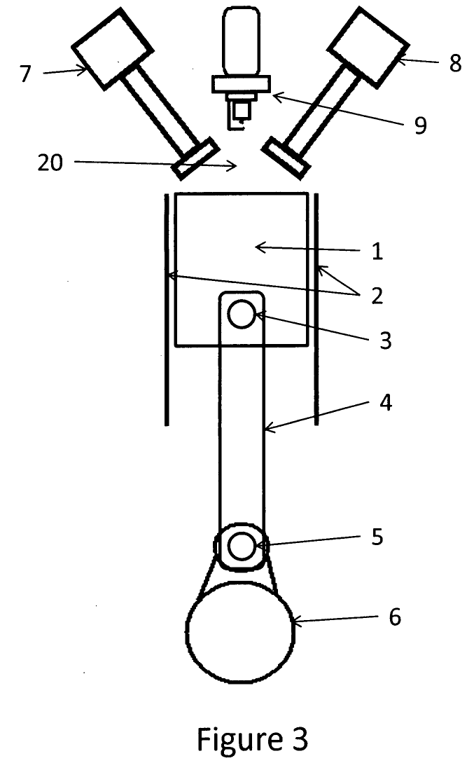

FIG. 4 is a partial schematic of a conventional internal combustion engine during the intake stroke.

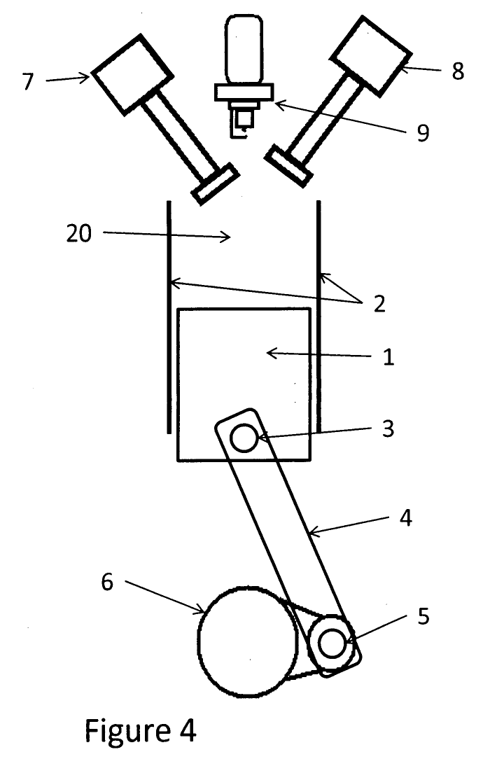

FIG. 5 is a partial schematic of an internal combustion engine near the start of the compression stroke.

FIG. 6 is a partial schematic of an internal combustion engine about halfway through the compression stroke.

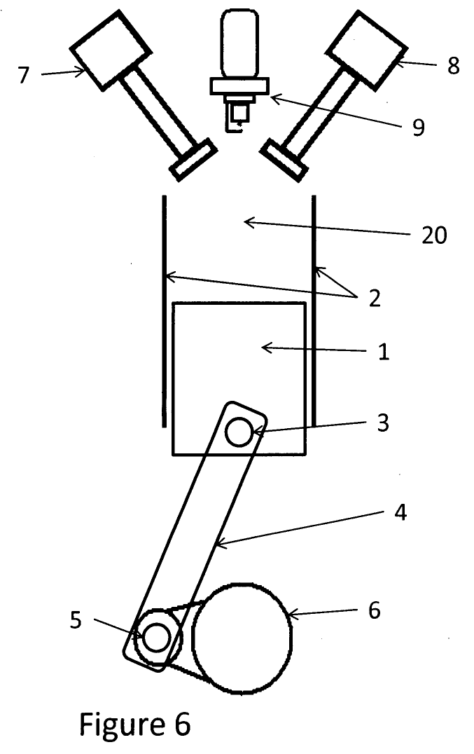

FIG. 7 is a partial schematic of an internal combustion engine near the start of the power stroke.

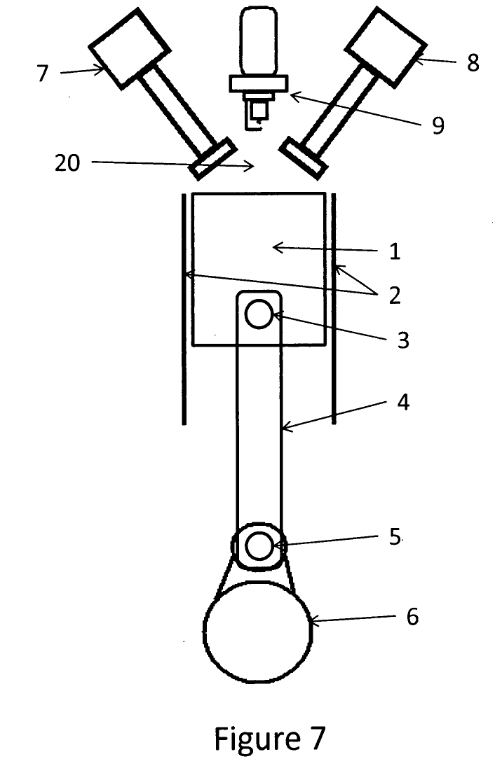

FIG. 8 is a partial schematic of an internal combustion engine near the start of the exhaust stroke.

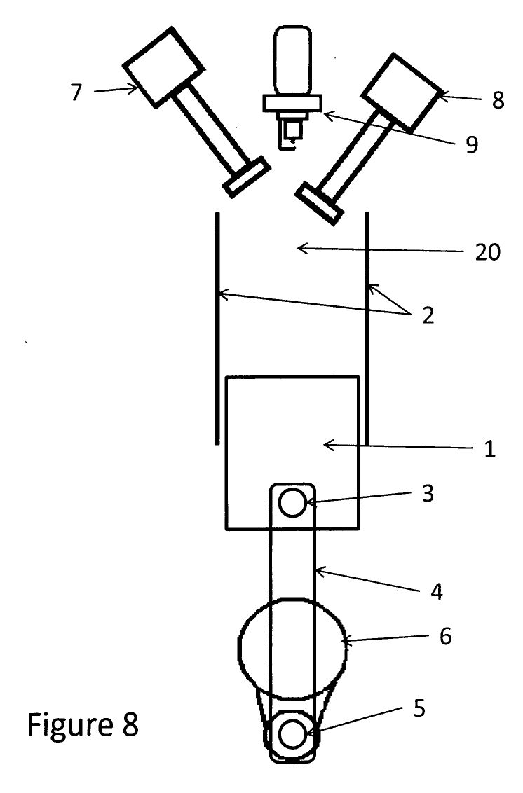

FIG. 9 is a partial schematic of an internal combustion engine about halfway through the power stroke.

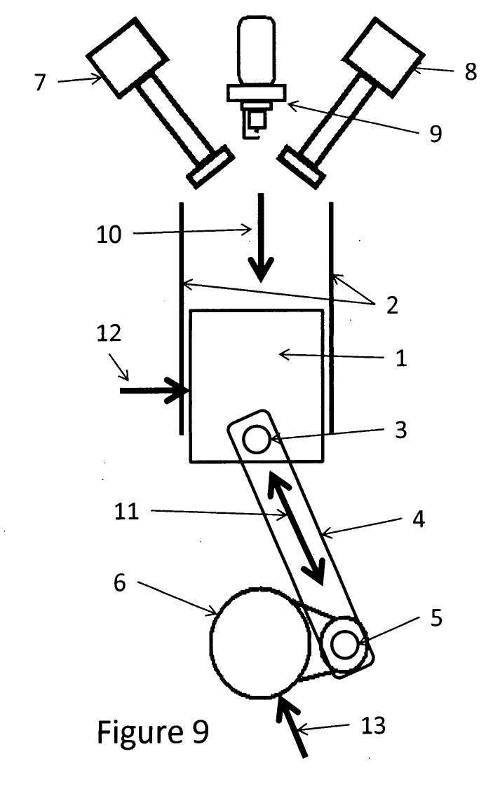

FIG. 10 is a partial schematic of engine of FIG. 2.

FIG. 11 is a partial schematic of the engine of FIG. 2 near the end of the intake stroke.

FIG. 12 is a partial schematic of the engine of FIG. 2 at about halfway through the power stroke.

FIG. 13 is a partial schematic of the engine of FIG. 2 showing how the valves can be extended into a truncated cylinder to increase combustion ratio.

FIG. 14 is a partial schematic of the engine of FIG. 2 showing how a tapered truncation can be used along with dome pistons.

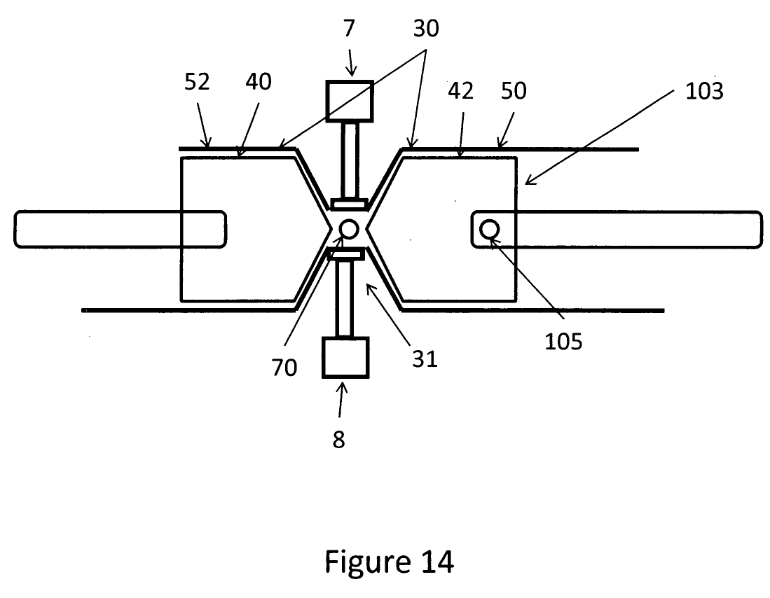

### DETAILED DESCRIPTION OF THE PREFERRED EMBODIMENT OF THE INVENTION

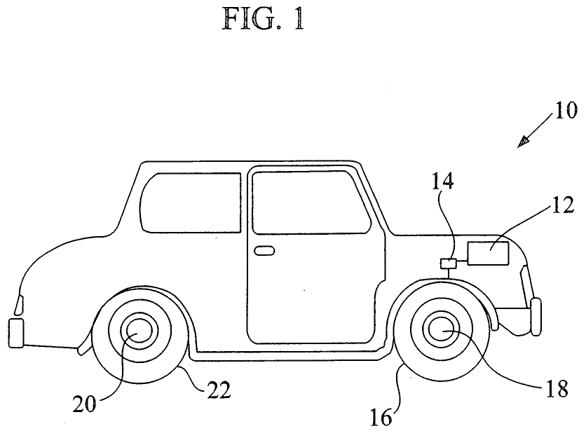

Referring now to FIG. 1, there is shown a selectively movable assembly 10 (such as a vehicle) which is made in accordance with the teachings of the preferred embodiment of the invention. It should be realized that the selectively movable assembly may comprise an automobile, a truck, a cross over type vehicle, or any other assembly which is selectively driven or moved by an engine. The present inventions are not constrained by a certain type of selectively movable assembly.

The assembly 10 includes an engine 12 which is made in accordance with the teachings of the preferred embodiment of the invention and the engine 12 is coupled (by use of the crankshaft portion 14) to wheels 16, 18. It should be realized however that while the selectively movable assembly 10 is shown as a front wheel drive assembly, (i.e., in this non-limiting configuration, the front wheels 16, 18 are driven), the present inventions are not limited to such an assembly. Rather, the crankshaft 14 may provide output power or torque to the rear wheels 20, 22 in a rear wheel drive configuration, to all of the wheels 16,18,20,22 in an all wheel drive configuration, and/or may even be used to provide torque to a winch or other assembly. The coupling of the torque or power producing crankshaft 14 to wheels 16-22 is well understood and typically requires a transmission assembly (not shown) which is coupled to the crankshaft 14 and to the wheels 16-20 in order to effectuate the transmission or transfer of the produced torque to the wheels 16-20.

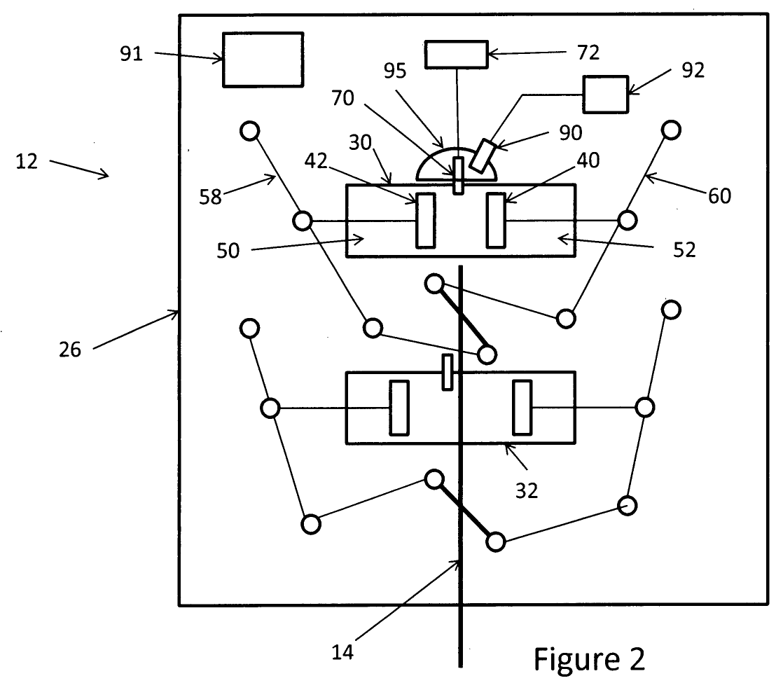

To further understand the teachings of the present invention, reference is now made to engine 12 which is more fully shown in FIG. 2. Particularly, in this non-limiting embodiment, engine 12 comprises a body or engine block 26 which contains a plurality of cavities or cylinders, such as cylinders 30, 32. In one non-limiting embodiment of the invention, each of the contained cylinders, such as cylinders 30, 32 are substantially similar.

Further, in each cylinder, such as in each of the respective cylinders 30, 32 there are two pistons. An explanation of the pistons 40, 42 which reside within cylinder 30 will now follow. It should be realized that the discussion of these two contained pistons 40, 42 and of their operation and use within the cylinder 30 is also applicable to and is substantially similar to the operative description of each of the other pairs of pistons which respectively and operatively reside in each of the other contained cylinders, such as cylinder 32.

Pistons 40, 42 are operatively disposed at opposed ends 50, 52 of the cylinder 30 and are respectively coupled to the crankshaft 14 by arm assemblies 58, 60. The cylinder 30 further includes a selectively energizable spark plug 70 which is positioned within the cylinder 30 between the contained pistons 40, 42. In one non-limiting embodiment, the contained spark plug 70 is in the middle between the contained pistons 40, 42 and in another non-limiting embodiment, the contained spark plug is closer towards one of the contained pistons 40, 42. The spark plug 70 is coupled to a source of electrical energy 72. Air and fuel are provided to and exhaust gases exhausted from the cylinder 30 by a manifold assembly 95 which includes fuel injector 90. Fuel injector 90 is coupled to a source of fuel 92 and selectively provides fuel to cylinder 30. Alternately, fuel injector 90 can supply fuel directly to the cylinder as a direct-injection system. Alternately, separate intake and exhaust manifolds can be used. It should be appreciated that, in one non-limiting embodiment, the operation of the fuel injector 90, spark plug 70, and air manifold assembly 95 is controlled by processor 91 which is operable under stored program control.

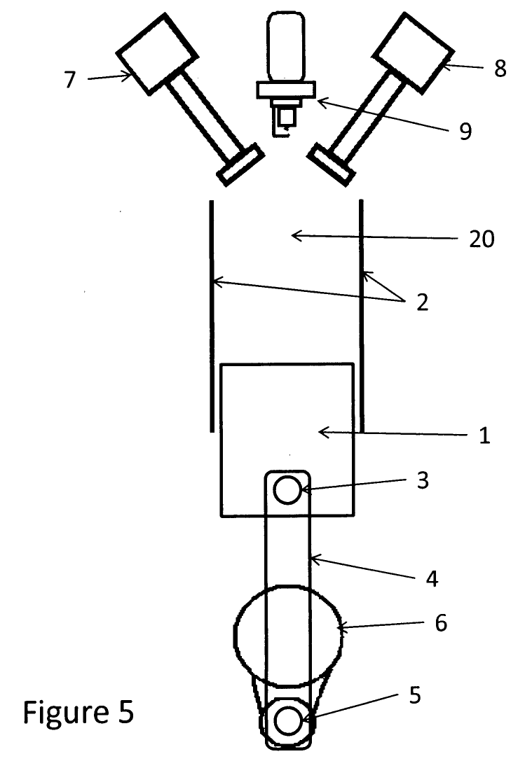

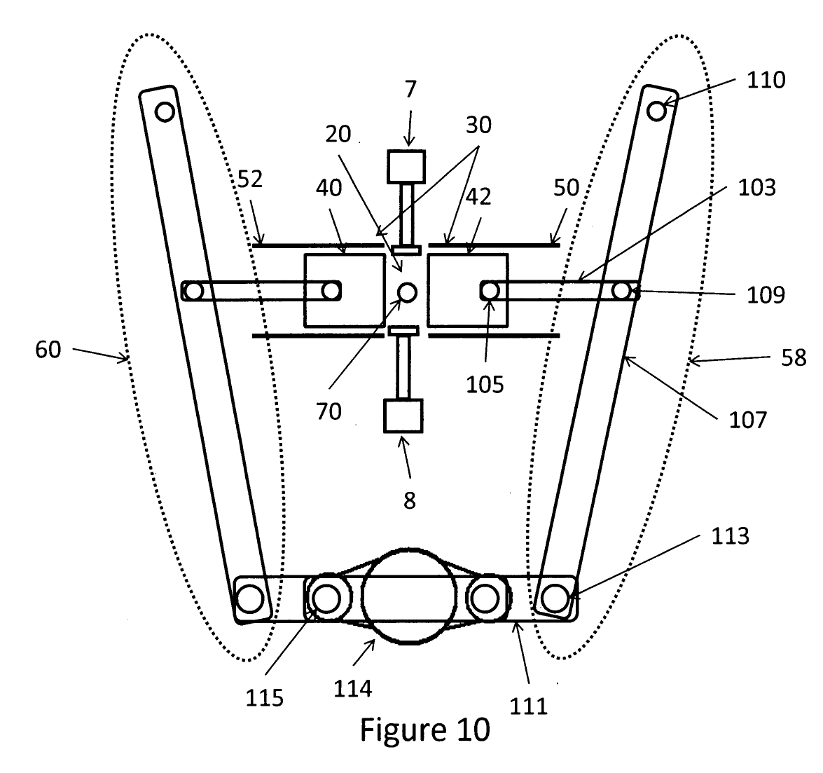

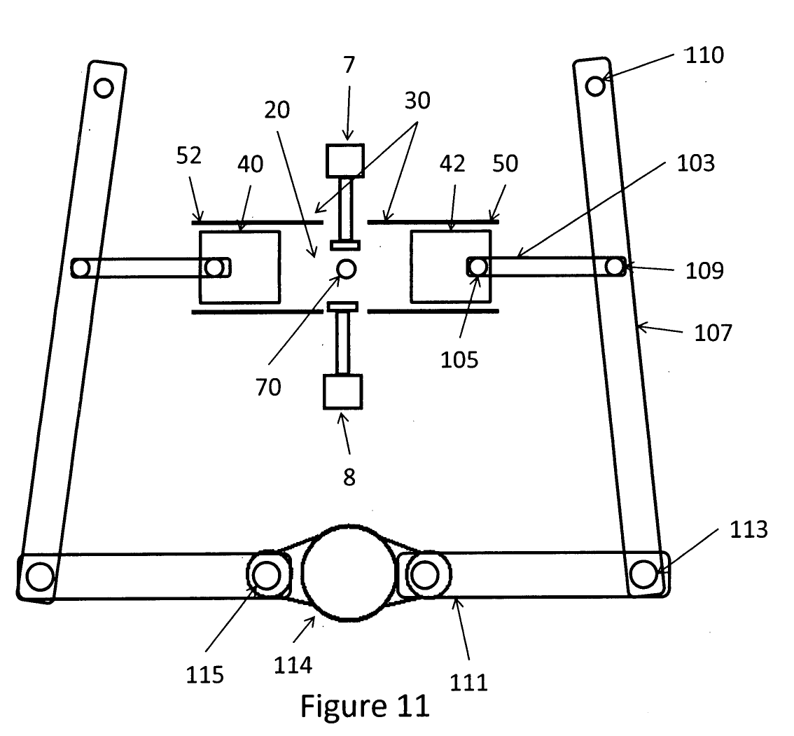

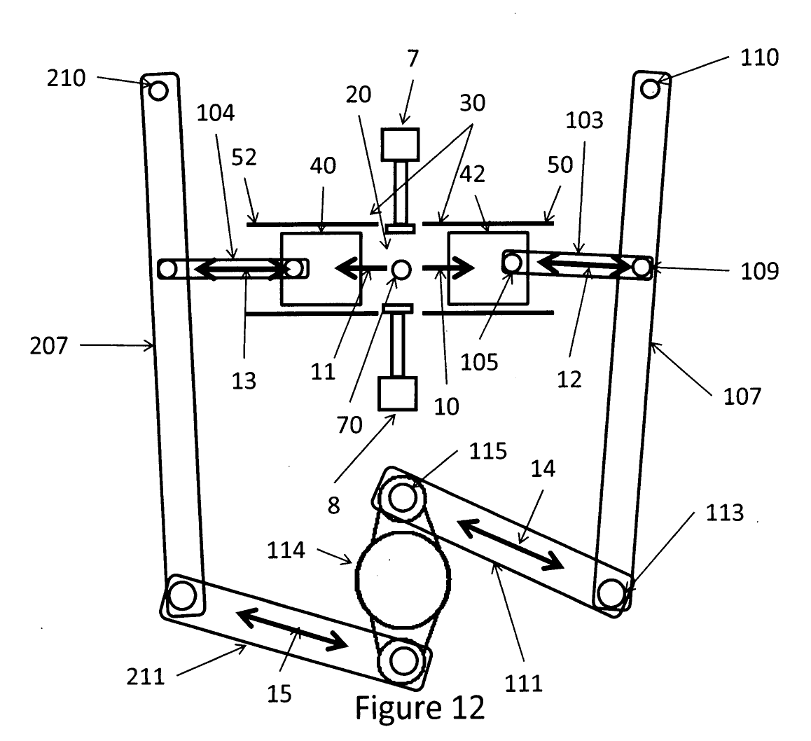

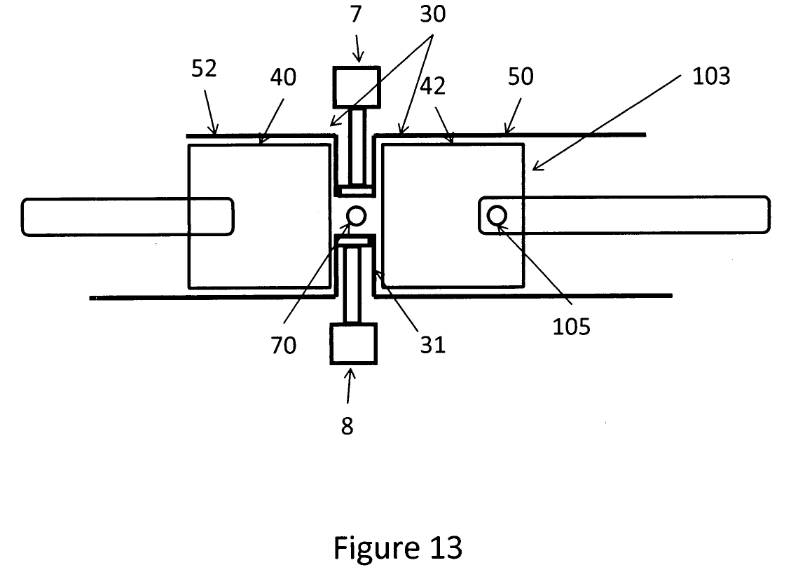

FIG. 10 is a detail view of the engine of FIG. 2. It shows volume 20 bounded by two pistons 40 and 42, inlet valve 7, exhaust valve 8, a head assembly (not shown), and spark plug 70. As the crank rotates, both pistons 40 and 42 move along the cylinder 30 to expand or contract the bounded volume 20 in a manner similar to the conventional engine previously discussed. The engine produces power through the same four-stroke process previously discussed: Intake, Compression, Power, and Exhaust. FIG. 11 is the same engine near the end of the Intake stroke with inlet valve 7 still open. It should be noted that for the same cylinder 30 interior diameter and engine displacement, each piston 40 and 42 travels only ½ of the distance (and therefore travels at ½ of the speed) of a piston in a conventional engine, such as piston 1 in FIG. 5. FIG. 12 is the same engine as FIG. 10 with the crankshaft 114 about halfway into the Power stroke. In this engine, the ignition of the compressed gases in volume 20 generates forces on piston 40 and piston 42. The force on piston 42 is transmitted to rod 103, and reaction force 12 is generated in the rod 103. Likewise the force on piston 40 is transmitted to rod 104, and reaction force 13 is generated in the rod 104. Through the pivoting action of arm 107 in pin 110, force vector 14 is generated in rod 111, which then transmits the force to crankshaft 114. Likewise, force vector 15 is generated is rod 211 from the pivoting action of arm 207 about pin 210. Observe that force 12 is nearly in line with piston 42 travel direction vector 10, minimizing the generation of a reaction force from piston 42 onto the wall of cylinder 30. Likewise, force 13 is nearly in line with piston 40 travel direction vector 11, minimizing the generation of a reaction force from piston 40 onto the wall of cylinder 30. Also, the force vector 14 in member 111 which is imparted on the crankshaft 114 is nearly balanced with force vector 15, minimizing the generation of a reaction force from the engine block (not shown) onto the crank. FIG. 12 is a detail view showing how the intake valve 7 and exhaust valve 8 can extend into the cylinder 30 with the introduction of a truncation 31 in the cylinder. This allows the valves 7 & 8 to be closed when the pistons 40 & 42 are at the limit of their travel. FIG. 13 is the same, with dome pistons used instead of flat-top pistons, and the cylinder truncation tapered.

It should be pointed out that for the same compression ratio as a conventional engine, the piston velocity in and engine with a plurality N of pistons will be reduced by 1/N. Since measurements of engine friction have shown it to increase by 400% with a doubling of engine speed, an engine with two pistons working together at ½-speed would demonstrate a 75% reduction in friction, which by convention should yield a 15% increase in engine power and efficiency.

It is to be understood that the inventions are not limited to the exact construction or method which has been illustrated above, but that various changes and modifications may be made without departing from the spirit and the scope of the inventions as are more fully delineated in the following claims.

What is claimed is:

1) An engine having a body into which at least one cylinder is formed: a plurality of pistons which are movably disposed within said at least one cylinder; a crankshaft; a plurality of arm assemblies, wherein each of said plurality of arm assemblies connects a unique one of said pistons to said crankshaft; at least one spark plug which is operatively disposed within said at least one cylinder and which is selectively energizable, wherein said selective energization of said at least one spark plug causes each of said plurality of pistons to move in a respectively unique direction within said at least one cylinder and wherein said movement of each of said plurality of pistons causes each of said plurality of arm assemblies to cooperatively rotate said crankshaft, thereby causing said engine to provide rotational energy.

2) The engine of claim 1 wherein each of said pistons are substantially identical.

3) The engine of claim 2 wherein each of said plurality of arm assemblies is substantially identical.

4) The engine of claim 3 wherein said at least one spark plug is operatively disposed within said middle of said at least one cylinder.

5) An engine comprising a body into which a cylinder is formed; a first piston which is movably disposed within said cylinder; a second piston which is movably disposed within said cylinder; a crankshaft; a first arm assembly which couples said first piston to said crankshaft; a second arm assembly which couples said second piston to said crankshaft; a spark plug which is operatively disposed within said cylinder, which is positioned between said first and said second pistons while being closer to said first of said pistons and which is selectively energizable, wherein when said spark plug becomes selectively energized said first and said second pistons are made to move away from each other in opposite directions within said cylinder, effective to cause said first and second arm assemblies to cooperatively rotate said crankshaft, thereby providing rotational energy.

6) The engine of claim 5 wherein each of said first and second pistons are substantially identical.

7) The engine of claim 6 wherein said first and said second arm assemblies are substantially identical.

8) A selectively movable assembly comprising an engine having a body into which at least one cylinder is formed: a plurality of pistons which are movably disposed within said at least one cylinder; a crankshaft; a plurality of arm assemblies, wherein each of said plurality of arm assemblies connects a unique one of said pistons to said crankshaft; at least one spark plug which is operatively disposed within said at least one cylinder and which is selectively energizable, wherein said selective energization of said at least one spark plug causes each of said plurality of pistons to move in a respectively unique direction within said at least one cylinder and wherein said movement of each of said plurality of pistons causes each of said plurality of arm assemblies to cooperatively rotate said crankshaft, thereby causing said engine to provide rotational energy.

9) A method for concomitantly increasing the output torque and the efficiency of an internal combustion engine of the type having at least on contained and selectively movably piston, said method comprising the step of reducing the speed of movement of said piston.
